(19) United States
(12) Patent Application Publication
(10) Pub. No.: US 2010/0030643 A1
(43) Pub. Date: Feb. 4, 2010

(54) Publishing Advertisements Based on Presence Information of Advertisers

(75) Inventor: Lior Meir Sion, Tel Aviv (IL)

Correspondence Address: KALI LAW GROUP, P.C., P.O. BOX 60187, SUNNYVALE, CA, 94088-0187, US

(73) Assignee: International Business Machines Corporation, Armonk, NY (US)

(21) Appl. No.: 12/182,796

(22) Filed: Jul. 30, 2008

(51) Int. Cl. G06Q 30/00

(52) U.S. Cl. 705/14.49; 705/1

(57) ABSTRACT

Publishing advertisements based on presence information of advertisers. For example, a method for dynamically publishing content items includes: determining a presence status value of a provider of a content item to be published on a communication network site; selecting from a plurality of versions of said content item a version of said content item corresponding to said presence status value; and publishing on said communication network site data representing the selected version of said content item.

### FIELD

Some embodiments are related to the field of online advertising.

### BACKGROUND

Some global communication systems, for example, the Internet or the World Wide Web, allows user to utilize computing devices in order to access online content. For example, a user may utilize a personal computer in order to visit various web-sites. Some web-sites present the user with advertisements or commercial offers related to various goods and services.

Some web-sites utilize an advertisement server in order to dynamically serve advertisements that are selected based on keywords. For example, some advertisement servers select an advertisement from an advertisement repository based on one or more keywords that match a search query that the user entered, e.g., in a search engine.

### SUMMARY

Some embodiments include, for example, devices, systems and methods of publishing advertisements based on presence information of advertisers.

Some embodiments include, for example, a method for dynamically publishing content items, the method including: determining a presence status value of a provider of a content item to be published on a communication network site; selecting from a plurality of versions of said content item a version of said content item corresponding to said presence status value; and publishing on said communication network site data representing the selected version of said content item.

In some embodiments, determining includes: sending a presence status query to a presence server able to store presence status information of a plurality of content providers; and receiving from the presence server a presence status response indicating the presence status value of said content provider.

In some embodiments, determining includes: detecting the presence status value of the provider based on a presence status detection mechanism selected from the group consisting of: a mechanism to detect presence status of the content provider using Instant Messaging data; and a mechanism to detect presence status of the content provider using cellular network information.

In some embodiments, the presence status value comprises a value selected from the group consisting of: available, unavailable, busy, silent, meeting, be right back, online, and offline.

In some embodiments, the plurality of versions of the content item comprise: a first version corresponding to a first file format; and a second version corresponding to a second, different, file format.

In some embodiments, the first file format includes a textual file format, and the second file format includes a graphical file format.

In some embodiments, the plurality of versions of the content item include: a first version including an invitation to contact the provider by a first communication method; and a second version including an invitation to contact the provider by a second, different, communication method.

In some embodiments, selecting includes: selecting a version of the content item based on a presence status of an intended audience member of the content item.

In some embodiments, the method includes: sending a presence status query to a presence server able to store presence status information of a plurality of intended audience members; and receiving from the presence server a presence status response indicating the presence status value of said intended audience member.

In some embodiments, the method includes: detecting the presence status value of the intended audience member based on a presence status detection mechanism selected from the group consisting of: a mechanism to detect presence status of the intended audience member using Instant Messaging data; and a mechanism to detect presence status of the intended audience member using cellular network information.

In some embodiments, the content item includes a content item selected from the group consisting of: an advertisement, a textual advertisement, a graphical advertisement, an audio advertisement, a video advertisement, an audio/video advertisement, a banner, a promotional content item, a coupon, a discount representation, a contact detail of a service provider, and a contact detail of a product provider.

Some embodiments include, for example, an apparatus for dynamically publishing content items, the apparatus including: a server to determine a presence status value of a provider of a content item to be published on a communication network site; to select from a plurality of versions of said content item a version of said content item corresponding to said presence status value; and to publish on said communication network site data representing the selected version of said content item.

Some embodiments include, for example, a system for dynamically publishing advertisements, the system including: a presence server to determine a presence status value of a provider of an advertisement to be published on a communication network site, the presence server associated with one or more presence detectors able to detect the presence status of said provider; an advertisement repository to store a plurality of versions of said advertisement; an advertisement selector to select from the plurality of versions of said advertisement a version of said advertisement corresponding to said presence status value; and an advertisement server to server to said communication network site data representing the selected version of said advertisement.

Some embodiments may include, for example, a computer program product including a computer-useable medium including a computer-readable program, wherein the computer-readable program when executed on a computer causes the computer to perform methods in accordance with some embodiments of the invention.

Some embodiments may provide other and/or additional benefits and/or advantages.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system in accordance with some demonstrative embodiments of the invention.

FIG. 2 is a schematic flow-chart of a method of publishing advertisements, in accordance with some demonstrative embodiments of the invention.

### DETAILED DESCRIPTION

In the following detailed description, numerous specific details are set forth in order to provide a thorough understanding of some embodiments of the invention. However, it will be understood by persons of ordinary skill in the art that some embodiments may be practiced without these specific details. In other instances, well-known methods, procedures, components, units and/or circuits have not been described in detail so as not to obscure the discussion.

The terms “plurality” or “a plurality” as used herein include, for example, “multiple” or “two or more”. For example, “a plurality of items” includes two or more items.

Although portions of the discussion herein relate, for demonstrative purposes, to wired links and/or wired communications, some embodiments are not limited in this regard, and may include one or more wired or wireless links, may utilize one or more components of wireless communication, may utilize one or more methods or protocols of wireless communication, or the like. Some embodiments may utilize wired communication and/or wireless communication.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device (e.g., a device incorporating functionalities of multiple types of devices, for example, PDA functionality and cellular phone functionality), a vehicular device, a non-vehicular device, a mobile or portable device, a non-mobile or non-portable device, a wireless communication station, a wireless communication device, a wireless Access Point (AP), a wireless Base Station (BS), a Mobile Subscriber Station (MSS), a wired or wireless Network Interface Card (NIC), a wired or wireless router, a wired or wireless modem, a wired or wireless network, a Local Area Network (LAN), a Wireless LAN (WLAN), a Metropolitan Area Network (MAN), a Wireless MAN (WMAN), a Wide Area Network (WAN), a Wireless WAN (WWAN), a Personal Area Network (PAN), a Wireless PAN (WPAN), devices and/or networks operating in accordance with existing IEEE 802.11, 802.11a, 802.11b, 802.11g, 802.11n, 802.16, 802.16d, 802.16e, 802.16m standards and/or future versions and/or derivatives of the above standards, units and/or devices which are part of the above networks, one way and/or two-way radio communication systems, cellular radio-telephone communication systems, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or tag or transponder, a device which utilizes Near-Field Communication (NFC), a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, a “smartphone” device, a wired or wireless handheld device (e.g., BlackBerry (R™), Palm (R™) Treo (™)), a Wireless Application Protocol (WAP) device, or the like.

Some embodiments may be used in conjunction with one or more types of wireless communication signals and/or systems, for example, Radio Frequency (RF), Infra Red (IR), Frequency-Division Multiplexing (FDM), Orthogonal FDM (OFDM), OFDM Access (OFDMA), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, Multi-Carrier Modulation (MDM), Discrete Multi-Tone (DMT), Bluetooth (R™), Global Positioning System (GPS), IEEE 802.11 (“Wi-Fi”), IEEE 802.16 (“Wi-Max”), ZigBee (™), Ultra-Wideband (UWB), Global System for Mobile communication (GSM), 2G, 2.5G, 3G, Third Generation Partnership Project (3GPP), 3GPP Long Term Evolution (LTE), 3.5G, or the like. Some embodiments may be used in conjunction with various other devices, systems and/or networks.

The terms “wireless device”, “wireless computing device”, “mobile device” or “mobile computing device” as used herein include, for example, a device capable of wireless communication, a communication device or communication station capable of wireless communication, a computer capable of wireless communication, a mobile phone, a cellular phone, a laptop or notebook computer capable of wireless communication, a PDA capable of wireless communication, a handheld device capable of wireless communication, a portable or non-portable device capable of wireless communication, or the like.

The terms “content”, “content item”, “advertisement” or “ad” as used herein include, for example, advertising or advertising-related content, promotional content, discounts, coupons, banners, slogans, logos, announcements, marketing materials, sales materials, contact details, contact information, prices, invitation to contact a provide or products and/or services, description of products and/or services, advertisements for commercial and/or non-commercial entities (e.g., for corporations or for non-for-profit organizations), advertisements for individuals and/or legal entities, textual and/or visual and/or graphical advertisements or content, audio content, video content, audio/video content, or the like.

Although portions of the discussion herein relate, for demonstrative purposes, to publication of advertisements by advertisers, other content items and other types of content may be published or advertised, and other types of publishers or content providers may publish, advertise, or provide content.

Although portions of the discussion herein relate, for demonstrative purposes, to displaying of an advertisement or of content to a viewer, other types of presentations may be used (e.g., generation of audible content, music, narration, or the like), and other types of audiences or audience members may be addressed (e.g., listeners, listeners/viewers, or the like). As an overview, some embodiments include, for example, devices, systems, and methods of publishing advertisements based on presence information of advertisers. For example, an advertiser submits to an ad repository multiple ads: a first ad, intended for serving when the presence status of the advertiser is “available”; a second ad, intended for serving when the presence status of the advertiser is “unavailable”; and a third ad, intended for serving when the presence status of the advertiser is “busy”. An ad server selects the advertiser based on one or more ad selection criteria (e.g., keywords), and then selects one ad from the multiple ads of that advertiser based on the current presence status of the advertiser, as retrieved from a presence server in substantially real time.

Some embodiments allow both the advertiser and the user (e.g., the viewer of the ad) to benefit from a more dynamic type of advertising, which supports presence information, thereby allowing the advertiser to provide better service or improved options depending on the presence status of the advertiser. For example, when the presence status of the advertiser is “unavailable”, the ad server selects and serves an ad that conveys general information about the advertiser; but when the presence status of the advertiser is “available”, the ad server selects and serves an ad that invites the viewer to contact the advertiser, for example, by calling the cellular phone of the advertiser, or by launching a live chat session between the viewer and the advertiser.

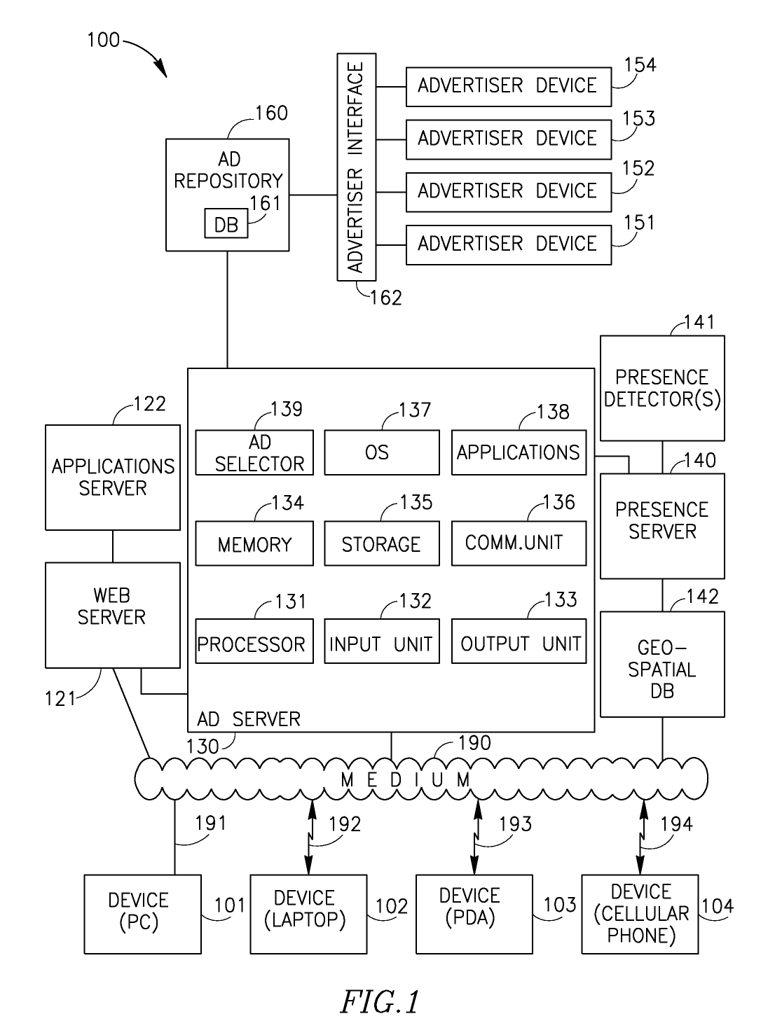

FIG. 1 schematically illustrates a block diagram of a system 100 in accordance with some demonstrative embodiments of the invention. System 100 includes one or more computing devices or mobile devices, for example, devices 101-104. For example, device 101 may be a Personal Computer (PC) having a cable modem; device 102 may be a laptop computer having an IEEE 802.16 transceiver; device 103 may be a Personal Digital Assistant (PDA) having an IEEE 802.11 transceiver; and device 104 may be a cellular phone having a cellular transceiver. Devices 101-104 may communicate with a web-server 121, for example, utilizing a medium 190 as well as wired and/or wireless communication links 191-194.

The medium 190 may be or may include, for example, a shared access medium, a global communication network, the Internet, the World Wide Web, a wired network, a wireless network, a combination of one or more wired networks and/or one or more wireless networks, or the like. In some embodiments, medium 190 may include one or more communication networks, for example, an a-synchronic or asynchronous wireless network, a synchronic wireless network, a managed wireless network, a non-managed wireless network, a burstable wireless network, a non-burstable wireless network, a scheduled wireless network, a non-scheduled wireless network, or the like.

Web-server 121 is configured to serve web-pages or other content (e.g., HTML content, Java applets, JavaScript content, Adobe Flash content, or the like) to devices 101-104. Web-server 121 is optionally associated with an applications server 122. Web-server 121 is further associated with an advertisement server (“ad server”) 130. The ad server 130 includes an ad selector 139 able to dynamically select an ad from an ad repository 160 based on particular selection criteria; the selected ad is then dynamically served by the ad server 130. In some embodiments, the selected ad is served by the ad server 130 directly to the relevant devices 101-104; in other embodiments, the selected ad is transferred by the ad server 130 to the web-server 121, which in turn incorporates the ad into content served by the web-server 121 to the relevant devices 101-104. In some embodiments, ad server 130 may be a component of web-server 121, or may be otherwise integrated with web-server 121.

The ad repository 160 includes representations of content of multiple advertisements associated, respectively, with multiple devices of publishers or advertiser. For demonstrative purposes, four advertiser devices 151-154 may utilize system 100 in order to publish online advertisements or other content items to one or more of devices 101-104. For example, advertiser device 151 may include a Personal Computer (PC) having a cable modem; advertiser device 152 may include a laptop computer having an IEEE 802.16 transceiver; advertiser device 153 may include a Personal Digital Assistant (PDA) having an IEEE 802.11 transceiver; and advertiser device 151 may utilize or may include a cellular phone having a cellular transceiver. In some embodiments, advertiser devices 151-154 may utilize an advertiser interface 162 provided by ad server 130 or coupled to ad repository 160, in order to submit textual or graphical advertisements to the ad repository 160, and in order to associate submitted advertisements with keywords or with particular ad selection criteria.

System 100 further includes a presence server 140, associated with one or more presence detectors 141, and optionally associated with a geo-spatial database 142. The presence server 140 is able to track, log and/or monitor the presence status of one or more users of system 100, for example, the presence status of users of devices 101-104, and/or the presence status of advertiser devices 151-154. Presence server 140 may utilize one or more presence detection mechanisms to determine presence status, for example, explicit input submitted by a device user (e.g., “I am unavailable”); explicit input submitted by a device user (e.g., a user of a cellular phone modifies its active profile from “general” to “silent” or “meeting”); presence status information received from an Instant Messaging (IM) application (e.g., indicating that a user is available, unavailable, busy, or “be right back”); power-save or stand-by information received from a mobile device (e.g., indicating that a device is turned off, turned on, goes into or out of “sleep” mode, goes into or out of stand-by mode, goes into or out of hibernation mode, or the like); information based on GPS data, triangulation data, geo-spatial information, presence zone information, or other presence-related information. In some embodiments, detection of the advertiser device's presence status may be based on publication of the presence status by the advertiser device to the presence server using one or more suitable protocols, for example, SIP, VP, XMPP, Presence Advanced Services for Telco Applications (PASTA), or the like.

The ad repository 160 includes a database 161 able to store advertisements submitted by advertiser devices 151-154, as well as keywords, presence status, advertisement content, and advertisement type. For demonstrative purposes, database 161 of ad repository 160 may be implemented using a table similar to the following table, denoted Table 1:

TABLE 1

| | | Presence | | Ad |
|---|---|---|---|---|
| Advertiser | Keywords | Status | Ad Content | Type |
| Joe_Smith | “toothache” OR | Unavailable | Ad_001.htm | Text |
| | “root canal” OR | | | |
| | “flossing” | | | |
| Joe_Smith | “toothache” OR | Available | Ad_002.java | Java |
| | “root canal” OR | | | |
| | “flossing” | | | |
| Joe_Smith | “toothache” OR | Busy | Ad_003.swf | Flash |
| | “root canal” OR | | | |
| | “flossing” | | | |
| Ann_Gold | (“PC problem” | Unavailable | Ad_101.gif | Graphic |
| | OR “Windows | | | |
| | problem”) | | | |
| | AND “Boston” | | | |
| Ann_Gold | (“PC problem” | Available | Ad_102.htm | Text |
| | OR “Windows | | | |
| | problem”) | | | |
| | AND “Boston” | | | |

For example, Table 1 includes five columns. The first column is denoted “Advertiser”, and includes a unique identifier of an advertiser or an advertise device. For demonstrative purposes, Table 1 shows two advertisers: a first advertiser denoted “Joe_Smith” (e.g., corresponding to a particular dentist), and a second advertiser denoted “Ann_Gold” (e.g., corresponding to a particular computer technician from Boston). The second column in Table 1 is denoted “keywords”, and includes keywords or keyword combinations (e.g., utilizing Boolean operators) that each advertiser selected. For example, as indicated in Table 1, the advertiser Joe Smith defined (e.g., using the advertiser interface 162) that his advertisements are to be served to users associated with the keyword “toothache”, or the keyword “root canal”, or the keyword “flossing”. Similarly, the advertiser Ann Gold defined (e.g., using the advertiser interface 162) that her advertisements are to be served to users associated with the keyword “Boston” and also associated with either the keyword “PC problem” or the keyword “Windows problem”). As further indicated in Table 1, each advertiser submits, using his advertiser device or using another device (e.g., a Personal Computer) to the ad repository 160 multiple versions of advertisements or content items, such that one of them is to be dynamically selected and served to users based on keywords (or other suitable ad selection criteria) and further based on substantially real-time presence status of the respective advertiser or advertise device. For example, the advertiser Joe Smith submitted to the ad repository 160 three ads: a first ad, represented by the file “Ad_{—}001.htm”, which is a textual ad to be presented when the presence status of Joe Smith (or the presence status of the computing device or mobile device of Joe Smith) is “unavailable”; a second ad, represented by the file “Ad_{—}002.java”, which is a Java applet ad to be presented when the presence status of Joe Smith (or the presence status of the computing device or mobile device of Joe Smith) is “available”; and a third ad, represented by the file “Ad_{—}003.swf”, which is a Flash-based ad to be presented when the presence status of Joe Smith (or the presence status of the computing device or mobile device of Joe Smith) is “busy”.

Accordingly, for example, when the cellular phone of Joe Smith has a presence status “unavailable”, the ad server 130 is to select the first ad of Joe Smith, which includes the text “Please visit our dentist offices located at 123 Main Street, Mondays to Fridays, from 9 AM to 5 PM”. In contrast, when the cellular phone of Joe Smith has a presence status “available”, the ad server 130 is to select the second ad of Joe Smith, which includes a Java applet guiding the user through various dental conditions and then inviting the user to call the cellular phone of the dentist Joe Smith (e.g., if the user indicated, through the Java applet, that the user is in pain and requests immediate dental assistance). Alternatively, when the cellular phone of Joe Smith has a presence status “busy”, the ad server 130 is to select the third ad of Joe Smith, which includes a Flash-based ad that conveys to the user, that the dentist office is generally open at this time, and that the user is invited to call the office phone number.

Similarly, as further indicated in Table 1, the advertiser Ann Gold submitted to the ad repository 160 two ads: a first ad, represented by the file “Ad_{—}101.gif”, which is a graphic ad to be presented when the presence status of Ann Gold (or the presence status of the computing device or mobile device of Ann Gold) is “unavailable”; and a second ad, represented by the file “Ad_{—}001.htm”, which is a textual ad to be presented when the presence status of Ann Gold (or the presence status of the computing device or mobile device of Ann Gold) is “available”.

Accordingly, for example, when the IM application running on the PDA of Ann Gold has a presence status “unavailable”, the ad server 130 is to select the first ad of Ann Gold, which conveys to the user the message “Please call me mobile phone and leave me a voice message”. In contrast, when the IM application running on the PDA of Ann Gold has a presence status “available”, the ad server 130 is to select the second ad of Ann Gold, which conveys to the user the message “I am available right now for online chat; please click here to launch a live chat session with me”.

In some embodiments, the ad server 130 searches the ad repository for an ad to be served, based on one or more search criteria; for example, a match between keywords selected by the advertiser and keywords detected in a search query that the user entered, or a match between keywords selected by the advertiser and keywords detected in email messages of the user. For example, the user of device 101 utilizes a search engine to search for the phrase “toothache”, and the ad server 130 determines that an advertisement of the advertise Joe Smith is to be served to this user. The ad server 130 dynamically selects one of the three advertisements submitted by the advertiser Joe Smith, based on the presence status of Joe Smith; the presence status information is retrieved by the ad server 130 from the presence server 140, for example, using an inquiry and response mechanism. Based on the retrieved presence status, the ad server 130 selects and serves the appropriate ad from the three ads submitted by the advertiser Joe Smith to the ad repository 160.

In some embodiments, submission of multiple ads to the ad repository 160, corresponding to multiple values of presence status of the advertiser or the advertiser device, may be optional and not mandatory. For example, a first advertiser (e.g., Joe Smith) may submit three ads to the ad repository 160, corresponding to three values of presence status of the first advertiser or advertiser device; whereas the second advertiser may submit a single advertisement to the ad repository 160, corresponding to any value of presence status of the second advertiser or advertise device. Accordingly, the ad server 130 may select the single ad of the second advertiser regardless of the presence status of the second advertiser; but may select an ad from the three ads of the first advertiser based on the presence status of the first advertiser or advertise device. This allows a common ad repository 160 and/or a common ad server 130 to serve ads for both the first advertiser (who is interested in presence status based advertising) and the second advertiser (who is not interested in presence status based advertising).

In some embodiments, one of the multiple version of an ad submitted by an advertiser may be defined by the advertiser (e.g., using the advertiser interface 162) as a default ad, to be selected and served by the ad server 130 if the presence status of the advertiser or the advertiser device is unknown, or cannot be obtained (e.g., temporarily, due to a technical problem with the presence server). In other embodiments, an advertiser may utilize the advertiser interface 162 to indicate, that none of her multiple versions of the advertisements are to be selected and served if the presence status of the advertiser or the advertise device is temporarily unknown; and in such case, the ad server 130 may select an ad of a different advertiser.

In some embodiments, the presence status of the advertiser or advertise device may be otherwise taken into account by the ad server 130, in combination with various other types of ad selection criteria. For example, in some embodiments, the ad server 130 may dynamically search for an ad, that is associated with the keyword “lunch”, that is represented as a graphical GIF file, that has a particular size in pixels (e.g., exactly 480 pixels by 60 pixels), that has a particular size in bytes (e.g., smaller than 15 kilobytes), and that is associated with an advertiser having a presence status of “available”. Other suitable combinations of search criteria may be used.

In some embodiments, the presence status information need not necessarily be taken into account as a last step in the ad selection process, and may be taken into account in the beginning of the ad selection process or in other parts thereof. For example, in some embodiments, the ad server 130 may first select a subset of ads that match the keyword “accountant”; may then select from this subset a smaller subset of ads associated with the presence status “available”; and may then select from this subset a smaller subset of ads that are represented by a JPEG file. Other suitable orders may be used for searching, filtering-out, filtering-in, or otherwise selecting ads, taking into account the presence value of the respective advertiser(s) or advertiser device(s).

Some embodiments allow advertisers to connect their presence to the ads that they advertise, such that ads are dynamically selected in relation to the real-time presence status of the respective advertiser or advertiser device. Some embodiments further allow an advertiser to offer special offers or promotions at different times, depending on the presence status of the advertiser or advertiser device. For example, an advertiser may define that when the advertiser's presence status is “unavailable”, an ad that conveys general contact information is to be selected and served; but when the advertiser's presence status is “available”, an ad that conveys an immediate contact information is presented (e.g., a cellular phone number) together with a promotional offer (e.g., “receive ten percent discount if you call within the next five minutes). Some embodiments may be configured to particularly benefit small-sized advertisers, e.g., an advertiser that includes one individual or few individuals equipped with a cellular phone and/or a PDA, in contrast with an a corporate advertiser having multiple customer-service representatives that are available 24 hours per day.

In some embodiments, by providing multiple options of ads, corresponding to multiple presence status values of an advertiser or advertiser devices, the content of the ad may be dynamically modified or changed based on the advertiser's presence status or the advertiser device's presence status. For example, a dentist may thus by able to advertise a first ad offering her services with a general link to her web-site when she is unavailable; a second ad inviting the user to place a direct phone call to the dentist when she is currently available on her mobile phone; or a third ad inviting the user to engage in a live chat session with the dentist when she is available on her IM application.

In some embodiments, one or more rules may be defined by an advertiser to handle multiple, concurrent, presence status values. For example, an advertiser may define that if the advertiser's mobile phone is “available”, and also the advertiser's IM application is concurrently “available”, then the ad version that invites the user to call the advertiser's mobile phone is to be selected, and not the ad version that invites the user to launch an online IM chat session. Other suitable rules, preferences, or priorities may be defined by the advertisers and may be utilized by the ad server 130.

In some embodiments, an advertiser may submit to the ad repository 160 an ad having a static portion (e.g., the message “Please contact me”) and a dynamic portion to be selected and inserted based on the presence status of the advertiser or advertiser device (e.g., the portion “by cellular phone” if the advertiser's cellular phone is “available”, or “by live chat” if the advertiser's IM application is available, or “by email” if none of the above is available). In some embodiments, only the dynamic portion of the ad may be selected and/or modified based on the presence status of the advertiser or advertiser device, and may be added to the static portion.

In some embodiments, a version or content of a particular advertisement of a particular advertiser is dynamically selected and served to match a presence status value of the advertiser. In other embodiments, an advertiser may utilize the system in order to dynamically advertise a first service or product when the advertiser's presence status has a first value, and to dynamically advertise a second, different, service or product when the advertiser's presence status has a second, different, value. For example, the different versions of the advertisement may relate, but need not necessarily relate, to the same service or product.

In some embodiments, the ad server may monitor, track and log statistical data related to ad selection and serving, for example, the number of times a particular ad (or a particular version of an ad) is served (e.g., number of “impressions”), the number of times that a hyperlink in the served ad is selected (e.g., number of “click-through”), or the like. In some embodiments, for example, an ad may “expire” and automatically removed from the ad repository if a pre-defined or pre-paid number of impressions is reached, or if a pre-defined or pre-paid number of click-through is reached. In some embodiments, each advertiser may utilize the advertiser interface 162 in order to view the statistical data related to his advertisements.

In some embodiments, the ad server 130 may dynamically select an ad based on one more ad selection criteria (e.g., keywords), based on presence status information of the advertiser or advertise device, and optionally also based on presence status information of the intended viewer (or listener, or audience member) of the advertisement or of the viewer's device. For example, the ad server 130 (or the presence server 140) may determine that the intended viewer of the advertisement, or his device, are located in a particular geo-spatial area, e.g., based on the viewer device's IP address and/or based on cellular triangulation or other presence detection data or mechanisms. The presence information of the intended viewer (or of his device) may be combined with the presence information of the advertiser (or of his device), and optionally with other ad selection criteria, to further refine the ad selection process. For example, if an intended viewer is located in a particular area and his cellular phone is “available”, and a relevant advertiser is also located in that area and his cellular phone is “available”, then a first ad version of the advertiser may be selected and served the by ad server 130, inviting the viewer to call the advertiser immediately in order to receive immediate services. In contrast, if the cellular phone of the viewer is “busy” and/or the cellular phone of the advertiser is “busy”, then a second ad version of the advertiser may be selected and served the by ad server 130, inviting the viewer to send an email to the advertiser (since the viewer and/or advertiser are occupied by cellular phone conversations). Other suitable mechanisms may be used to take into account both the advertiser's presence status and/or the viewer's presence status in the ad selection process.

In some embodiments, for example, the ad repository 162 or Table 1 may include additional data reflecting possible presence status values of an intended viewer of the advertisement, or possible presence status values of the device of an intended viewer of the advertisement. In such case, the ad server 130 may dynamically select an advertisement (or a version of an advertisement) by taking into account the presence status of the intended viewer. For example, in some embodiments, Table 1 may include additional column(s), indicating possible presence status values of the intended viewer or his device; and the ad selection process may take into account the information stored in the additional column(s).

In some embodiments, ad server 130 may be operated, owned or controlled by a first entity, for example, a digital marketing provider (e.g., “DoubleClick.com”); whereas web-server 131 may be operated, owned or controlled by a second entity, for example, a web content provider (e.g., “CNN.com”). In some embodiments, ad server 130 may be remote or significantly remote from web-server 131, or vice versa. In some embodiments, web-server 131 may serve web content associated with a particular publisher (e.g., “CNN.com”), whereas ad server 130 may serve advertisements associated with multiple advertisers (e.g., “McDonalds”, “The Gap”, “Home Depot”). In some embodiments, ad server 130 may be associated with a first Internet domain or top-level domain (e.g., “CNN.com”), whereas web-server 131 may be associated with a second, different, Internet domain or top-level domain (e.g., “DoubleClick.com”).

In some embodiments, ad server 130, web-server 121, presence server 140, ad repository 160, advertiser devices 151-154, devices 101-104, and/or other components of system 100 may communicate using the medium 190, e.g., utilizing one or more wireless and/or wired links. In some embodiments, one or more of these components may be remote, or significantly remote, from one or more other components (e.g., located in different cities, states, countries, or continents).

In some embodiments, sub-units that are shown, for demonstrative purposes, within a first component, may be implemented within a second component, or as independent component. For example, the presence detectors 141 and/or the geo-spatial database may be included in the presence server 140, associated with or coupled to the presence server 140, included in the ad server 130, associated with or coupled to the ad server 130, or may be implemented as separate or stand-alone units. Similarly, the ad repository 160 may be included in the ad server 130, may be associated with or coupled to the ad server 130, or may be implemented as a separate or stand-alone unit. Other suitable implementations may be used.

In some embodiments, presence status information, which is detected, obtained, and/or utilized by system 100, may include substantially real-time presence status information, or non real-time presence status information (e.g., presence status information delayed by 15 seconds). In some embodiments, “delayed” presence status information may be automatically updated at pre-defined time intervals, or may expire (e.g., may be replaced with a “presence status unknown” indicator) when a pre-defined delay period elapses.

System 100 may include other suitable hardware components and/or software components, in accordance with particular implementations. In some embodiments, the implementation may utilize alternate text or alternate advertisements published to the ad provider or channel (e.g., a search engine's advertising mechanism). In some embodiments, ad server 130 may utilize a rule set per advertiser, linking the advertisers presence profile (e.g., SIP ID, Sametime ID, email address, OpenId, or the like) with various versions of the advertiser's advertisement. For example, the rule set of a particular advertiser may define, that if the advertiser is “online” then a first ad is to be selected and served; if the advertiser is “busy” then a second ad is to be selected and served; and otherwise, a third ad is to be selected and served.

In some embodiments, ad server 130 may be implemented using suitable hardware components and/or software components, for example, a processor 131, an input unit 132, an output unit 132, a memory unit 134, a storage unit 135, and a communication unit 136

Processor 131 includes, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or other suitable multi-purpose or specific processor or controller. Processor 131 executes instructions, for example, of an Operating System (OS) 137 or of one or more applications 138.

Input unit 132 includes, for example, a keyboard, a keypad, a mouse, a touch-pad, a touch-screen, a joystick, a track-ball, a stylus, a microphone, or other suitable pointing unit or input device. Output unit 133 includes, for example, a monitor, a screen, a touch-screen, a Cathode Ray Tube (CRT) display unit, a Liquid Crystal Display (LCD) display unit, a plasma display unit, one or more audio speakers or earphones, or other suitable output devices.

Memory unit 134 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 135 includes, for example, a hard disk drive, a floppy disk drive, a Compact Disk (CD) drive, a CD-ROM drive, a Digital Versatile Disk (DVD) drive, an internal or external database or repository, or other suitable removable or non-removable storage units. Memory unit 134 and/or storage unit 135, for example, store data processed by ad server 130.

Communication unit 136 includes, for example, a wired or wireless transceiver, a wired or wireless modem, a wired or wireless Network Interface Card (NIC), or other unit suitable for transmitting and/or receiving communication signals, blocks, frames, transmission streams, packets, messages and/or data. Optionally, communication unit 136 includes, or is associated with, one or more antennas or one or more sets of antennas.

In some embodiments, some or all of the components of ad server 130 are enclosed in a common housing or packaging, and are interconnected or operably associated using one or more wired or wireless links. In other embodiments, components of ad server 130 are distributed among multiple or separate devices or locations.

In some embodiments, each one of devices 101-104, or each one of the devices of advertiser devices 151-154, may include, for example, a desktop computer, a laptop computer, a notebook computer, a tablet computer, a PDA device, a cellular phone, a mobile phone, a hybrid device (e.g., combining one or more cellular phone functionalities with one or more PDA device functionalities), a portable audio player, a portable video player, a portable audio/video player, a portable media player, a portable device having a touch-screen, a relatively small computing device, a non-desktop computer or computing device, a portable device, a handheld device, a “Carry Small Live Large” (CSLL) device, an Ultra Mobile Device (UMD), an Ultra Mobile PC (UMPC), a Mobile Internet Device (MID), a Consumer Electronic (CE) device, an “Origami” device or computing device, a device that supports Dynamically Composable Computing (DCC), a context-aware device, or the like.

Some embodiments may utilize client/server architecture, publisher/subscriber architecture, fully centralized architecture, partially centralized architecture, fully distributed architecture, partially distributed architecture, scalable Peer to Peer (P2P) architecture, or other suitable architectures or combinations thereof.

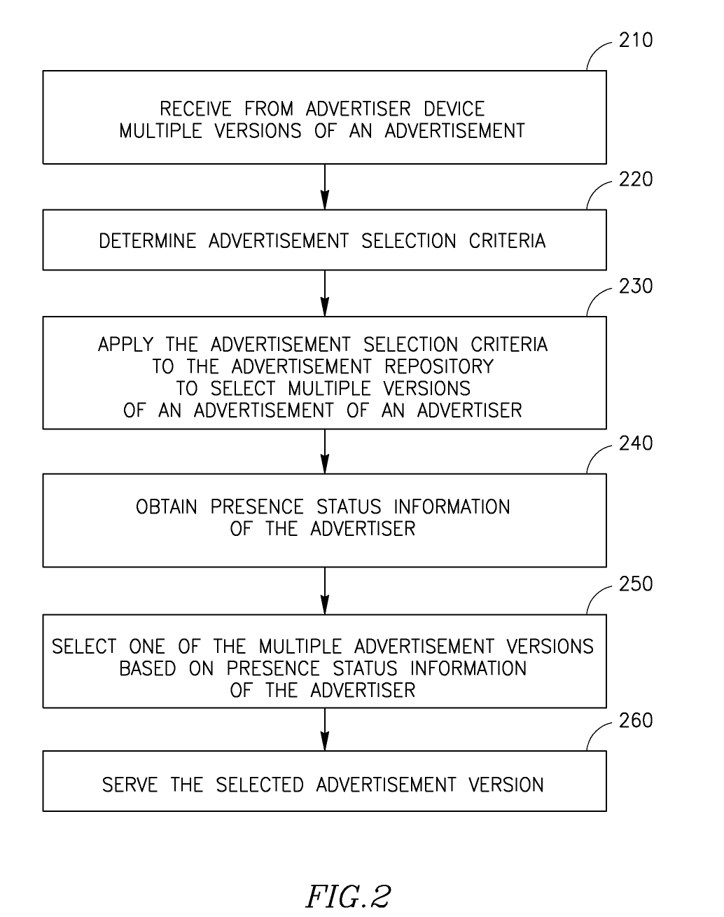

FIG. 2 is schematic flow-chart of a method of publishing advertisements, in accordance with some demonstrative embodiments of the invention. Operations of the method may be used, for example, by system 100 of FIG. 1, and/or by other suitable units, devices and/or systems.

In some embodiments, the method may include, for example, receiving from an advertiser device multiple versions (e.g., a batch of two or more versions) of an advertisement (or other content item) corresponding to multiple presence status values of the advertiser or advertiser device (block 210). This may be performed, for example, using an advertiser interface which allows an advertiser to upload, submit, or otherwise transfer ad versions from the advertiser device to an ad repository. Multiple versions may be received as a batch (e.g., a batch of three versions), or individually (e.g., a first ad version at a certain time and date, a second version added subsequently, and a third ad versions added subsequently). The received multiple versions of the ad may be stored in an ad repository.

In some embodiments, the method may include, for example, determining ad selection criteria, e.g., keywords (block 220). The ad selection criteria may be determined locally (e.g., by the ad server) or may be received from another local or remote component (e.g., a search engine, a web-mail application, an electronic commerce web-site).

In some embodiments, the method may include, for example, applying the ad selection criteria to the ad repository to select a batch of versions of a particular advertisement from the ad repository (block 230). For example, the selected advertisement may have multiple versions stored in the ad repository, corresponding to multiple presence status values of the selected advertiser or his device.

In some embodiments, the method may include, for example, obtaining presence status information of the selected advertiser or advertiser device (block 240). This may be performed, for example, by direct or indirect detection of presence status, by sending a presence status query to a presence server (e.g., the query having an identification of the advertiser) and receiving a presence status response from the presence server, by locally determining the presence status information, or by receiving from a remote unit the presence status information.

In some embodiments, the method may include, for example, selecting from the batch of multiple versions of the advertisement a version of the ad which corresponds to the presence status of the advertiser or his device (block 250).

In some embodiments, the method may include, for example, serving the selected version of the ad to a viewer (or listener, or other type of audience member) (block 260).

In some embodiments, other suitable operations may be used. For example, in some embodiments, the ad selection (block 230) and/or the version selection (block 250) may optionally take into account the presence status value of the intended viewer, and such presence status information may be detected or obtained prior to ad selection and/or version selection.

In some embodiments, operations may be performed in other suitable order. For example, the presence status information may be obtained subsequent to ad selection (e.g., in order to further select among multiple versions of a selected ad), or prior to or during the ad selection (e.g., utilizing the obtained presence status value as one of the ad selection criteria).

Some operations or sets of operations may be repeated, for example, substantially continuously, for a pre-defined number of iterations, or until one or more conditions are met. In some embodiments, some operations may be performed in parallel, in sequence, or in other suitable orders of execution

Discussions herein utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Some embodiments may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be or may include an electronic, magnetic, optical, electromagnetic, InfraRed (IR), or semiconductor system (or apparatus or device) or a propagation medium. Some demonstrative examples of a computer-readable medium may include a semiconductor or solid state memory, magnetic tape, a removable computer diskette, a Random Access Memory (RAM), a Read-Only Memory (ROM), a rigid magnetic disk, an optical disk, or the like. Some demonstrative examples of optical disks include Compact Disk-Read-Only Memory (CD-ROM), Compact Disk-Read/Write (CD-R/W), DVD, or the like.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Some embodiments may be implemented by software, by hardware, or by any combination of software and/or hardware as may be suitable for specific applications or in accordance with specific design requirements. Some embodiments may include units and/or sub-units, which may be separate of each other or combined together, in whole or in part, and may be implemented using specific, multi-purpose or general processors or controllers. Some embodiments may include buffers, registers, stacks, storage units and/or memory units, for temporary or long-term storage of data or in order to facilitate the operation of particular implementations.

Some embodiments may be implemented, for example, using a machine-readable medium or article which may store an instruction or a set of instructions that, if executed by a machine, cause the machine to perform a method and/or operations described herein. Such machine may include, for example, any suitable processing platform, computing platform, computing device, processing device, electronic device, electronic system, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit; for example, memory, removable or non-removable media, erasable or non-erasable media, writeable or re-writeable media, digital or analog media, hard disk drive, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, BASIC, Pascal, Fortran, Cobol, assembly language, machine code, or the like.

Functions, operations, components and/or features described herein with reference to one or more embodiments, may be combined with, or may be utilized in combination with, one or more other functions, operations, components and/or features described herein with reference to one or more other embodiments, or vice versa.

While certain features of some embodiments have been illustrated and described herein, many modifications, substitutions, changes, and equivalents may occur to those skilled in the art. Accordingly, the following claims are intended to cover all such modifications, substitutions, changes, and equivalents.

What is claimed is:

1. A method for dynamically publishing content items, the method comprising:
determining a presence status value of a provider of a content item to be published on a communication network site;
selecting from a plurality of versions of said content item a version of said content item corresponding to said presence status value; and
publishing on said communication network site data representing the selected version of said content item.

2. The method of claim 1, wherein determining comprises:
sending a presence status query to a presence server able to store presence status information of a plurality of content providers; and
receiving from the presence server a presence status response indicating the presence status value of said content provider.

3. The method of claim 1, wherein determining comprises:
detecting the presence status value of the provider based on a presence status detection mechanism selected from the group consisting of:
a mechanism to detect presence status of the content provider using Instant Messaging data; and
a mechanism to detect presence status of the content provider using cellular network information.

4. The method of claim 1, wherein the presence status value comprises a value selected from the group consisting of: available, unavailable, busy, silent, meeting, be right back, online, and offline.

5. The method of claim 1, wherein the plurality of versions of the content item comprise:
a first version corresponding to a first file format; and
a second version corresponding to a second, different, file format.

6. The method of claim 5, wherein the first file format comprises a textual file format, and wherein the second file format comprises a graphical file format.

7. The method of claim 1, wherein the plurality of versions of the content item comprise:
a first version including an invitation to contact the provider by a first communication method; and
a second version including an invitation to contact the provider by a second, different, communication method.

8. The method of claim 1, wherein selecting comprises:
selecting a version of the content item based on a presence status of an intended audience member of the content item.

9. The method of claim 8, comprising:
sending a presence status query to a presence server able to store presence status information of a plurality of intended audience members; and
receiving from the presence server a presence status response indicating the presence status value of said intended audience member.

10. The method of claim 8, comprising:
detecting the presence status value of the intended audience member based on a presence status detection mechanism selected from the group consisting of:
a mechanism to detect presence status of the intended audience member using Instant Messaging data; and
a mechanism to detect presence status of the intended audience member using cellular network information.

11. The method of claim 1, wherein the content item comprises a content item selected from the group consisting of: an advertisement, a textual advertisement, a graphical advertisement, an audio advertisement, a video advertisement, an audio/video advertisement, a banner, a promotional content item, a coupon, a discount representation, a contact detail of a service provider, and a contact detail of a product provider.

12. An apparatus for dynamically publishing content items, the apparatus comprising:
a server to determine a presence status value of a provider of a content item to be published on a communication network site; to select from a plurality of versions of said content item a version of said content item corresponding to said presence status value; and to publish on said communication network site data representing the selected version of said content item.

13. The apparatus of claim 12, wherein the server is to send a presence status query to a presence server able to store presence status information of a plurality of content providers; and to receive from the presence server a presence status response indicating the presence status value of said content provider.

14. The apparatus of claim 12, wherein the server is to detect the presence status value of the provider based on a presence status detection mechanism selected from the group consisting of:
a mechanism to detect presence status of the content provider using Instant Messaging data; and
a mechanism to detect presence status of the content provider using cellular network information.

15. The apparatus of claim 12, wherein the presence status value comprises a value selected from the group consisting of: available, unavailable, busy, silent, meeting, be right back, online, and offline.

16. The apparatus of claim 12, wherein the plurality of versions of the content item comprise:
a first version corresponding to a first file format; and
a second version corresponding to a second, different, file format.

17. The apparatus of claim 16, wherein the first file format comprises a textual file format, and wherein the second file format comprises a graphical file format.

18. The apparatus of claim 12, wherein the plurality of versions of the content item comprise:
a first version including an invitation to contact the provider by a first communication method; and
a second version including an invitation to contact the provider by a second, different, communication method.

19. The apparatus of claim 12, wherein the server is to select a version of the content item based on a presence status of an intended audience member of the content item.

20. The apparatus of claim 19, wherein the server is to send a presence status query to a presence server able to store presence status information of a plurality of intended audience members; and to receive from the presence server a presence status response indicating the presence status value of said intended audience member.

21. The apparatus of claim 19, wherein the server is to detect the presence status value of the intended audience member based on a presence status detection mechanism selected from the group consisting of:
a mechanism to detect presence status of the intended audience member using Instant Messaging data; and
a mechanism to detect presence status of the intended audience member using cellular network information.

22. The apparatus of claim 12, wherein the content item comprises a content item selected from the group consisting of: an advertisement, a textual advertisement, a graphical advertisement, an audio advertisement, a video advertisement, an audio/video advertisement, a banner, a promotional content item, a coupon, a discount representation, a contact detail of a service provider, and a contact detail of a product provider.

23. A computer program product comprising a computer useable medium including a computer readable program, wherein the computer readable program when executed on a computer causes the computer to perform a method comprising:
determining a presence status value of a provider of a content item to be published on a communication network site;
selecting from a plurality of versions of said content item a version of said content item corresponding to said presence status value; and
publishing on said communication network site data representing the selected version of said content item.

24. The computer program product of claim 23, wherein determining comprises:
sending a presence status query to a presence server able to store presence status information of a plurality of content providers; and
receiving from the presence server a presence status response indicating the presence status value of said content provider.

25. A system for dynamically publishing advertisements, the system comprising:
a presence server to determine a presence status value of a provider of an advertisement to be published on a communication network site, the presence server associated with one or more presence detectors able to detect the presence status of said provider;
an advertisement repository to store a plurality of versions of said advertisement;
an advertisement selector to select from the plurality of versions of said advertisement a version of said advertisement corresponding to said presence status value; and
an advertisement server to server to said communication network site data representing the selected version of said advertisement.
